(19) United States
(12) Patent Application Publication
(10) Pub. No.: US 2024/0278415 A1
(43) Pub. Date: Aug. 22, 2024

(54) DEVICE AND METHOD FOR ENGAGING A ZIPPER

(71) Applicant: Thomas Jefferson University, Philadelphia, PA (US)

(72) Inventor: Shawna Nguyen, Philadelphia, PA (US)

(21) Appl. No.: 18/443,564

(22) Filed: Feb. 16, 2024

Related U.S. Application Data
(60) Provisional application No. 63/485,344, filed on Feb. 16, 2023.

(51) Int. Cl. B25G 1/10

(52) U.S. Cl. CPC B25G 1/102

(57) ABSTRACT

A device for engaging a zipper is described. The device includes a cuff having a substantially flat central region with two opposing ends curved towards each other, thereby defining a cuff inner surface and an outer surface, and at least one extension extending outwardly from the outer surface of the cuff. Also described are methods of engaging or disengaging a zipper mechanism using the devices described herein.

### CROSS-REFERENCE TO RELATED APPLICATIONS

This application claims priority to and the benefit of U.S. Provisional Application No. 63/485,344, filed Feb. 16, 2023, the disclosure of which is incorporated herein by reference in its entirety.

### BACKGROUND OF THE INVENTION

People with conditions such as severe arthritis, cerebral palsy, spinal cord injuries, or strokes can experience difficulties with execution of fine motor skills. For example, such conditions make it very challenging to perform tasks such as pinching, gripping, forming a fist, and/or manipulating small objects. Unfortunately, these challenges make daily tasks such as opening or closing a zipper mechanism very difficult and frustrating.

To address these issues, universal zipper openers have been created to aid in some of these movements. However, many existing universal zipper openers still require the use of specific muscles and movements of the user's hands, causing unaddressed difficulty and/or lack of comfort when utilized.

Current technologies include a chain and hook design. However, to hook the device onto the zipper's outer ring, the user must still have moderate to advanced fine motor skills. For instance, the user must pinch the zipper tab and manipulate the hook to attach it to the outer ring. The user must also have a strong grip to hold and pull the chain. However, considering the diverse patient population and the severity of their conditions, those with, for example, arthritis or cerebral palsy may not have the hand skill and strength to perform those refined motor tasks.

Furthermore, many zipper openers currently on the market require the user to grip onto a rod or ring component. However, those with limited hand function, dexterity, and strength cannot pinch or form a first to hold onto the zipper opener. Also, most zipper openers only help users open or close a zipper and do not assist with the full dressing process.

Thus, there is a need in the art for a universal zipper opener that has limited use of hand muscles and movements, is easily removable independently, and assists in the bottom stop into the slider of a zipper. The present invention satisfies that need.

### SUMMARY OF THE INVENTION

A device for engaging a zipper is described. The device includes a cuff having a substantially flat central region with two opposing ends curved towards each other, thereby defining a cuff inner surface and an outer surface, and at least one extension extending outwardly from the outer surface of the cuff. In some embodiments, the at least one extension extends outwardly from the outer surface of the substantially flat region of the cuff. In some embodiments, the cuff is rigid in the substantially flat central region. In some embodiments, the cuff is flexible at the two opposing curved ends. In some embodiments, the at least one extension is a hook. In some embodiments, the at least one extension includes two hooks pointed in opposite directions. In some embodiments, the at least one extension includes two hooks pointed towards each other. In some embodiments, the at least one extension is releasably fixed to the cuff. In some embodiments, the inner surface is malleable. In some embodiments, the inner surface is padded. In some embodiments, the cuff includes a top edge and a bottom edge along its length, and wherein the length of the top edge is shorter than the length of the bottom edge. In some embodiments, the cuff has a width, and the width of the flat central portion is different than the width of the two opposing curved ends. In some embodiments, the cuff is configured to make a friction fit when positioned on a user's hand. In some embodiments, the cuff is configured such that the at least one extension extends outward from the dorsal side of the user's hand when the cuff is positioned on the user's hand.

Also described is a method for engaging and closing a zipper mechanism. The method includes the steps of positioning any of the devices herein described onto a user's hand, positioning a bottom stop of a zipper at or into a zipper slider, positioning the at least one extension of the cuff below the bottom stop and pushing the bottom stop fully into the slider via the cuff extension, engaging the at least one extension of the cuff with a zipper pull or handle, and pulling the zipper pull or handle upward via the cuff extension, such that the zipper mechanism is engaged.

Also described is a method for opening and disengaging a zipper mechanism. The method includes the steps of positioning any of the devices herein described onto a user's hand, engaging the at least one extension of the cuff with the zipper pull or handle, and pulling the zipper pull or handle downward via the cuff extension, such that the zipper mechanism is disengaged.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is an exemplary embodiment of a device for engaging a zipper.

FIG. 2 is a schematic of exemplary sectional portions of the device of FIG. 1.

FIG. 3A and FIG. 3B are images of the device of FIG. 1 positioned on a user's hand.

FIG. 4 is a flow chart of an exemplary method for engaging a zipper.

FIG. 5 is a set of images depicting the steps of an exemplary method for engaging a zipper.

FIG. 6 is another set of images depicting the steps of an exemplary method for engaging a zipper.

### DETAILED DESCRIPTION OF THE INVENTION

It is to be understood that the figures and descriptions of the present invention have been simplified to illustrate elements that are relevant for a clearer comprehension of the present invention, while eliminating, for the purpose of clarity, many other elements found in a device and method for engaging a zipper. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of +20%, +10%, +5%, +1%, and +0.1% from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

The invention described herein allows people with challenging physical conditions to utilize larger arm muscles instead of smaller hand muscles to open and close a zipper. The design of the present invention allows for easy and efficient positioning onto the user's hand without another person's assistance, thus promoting an individual's independence in daily tasks like zipping any garment or bag. Also, the design described herein allows users to slip the bottom stop of a zipper mechanism into the zipper slider, which is the first step of engaging the zipper and often is the most challenging aspect of zipping a jacket closed.

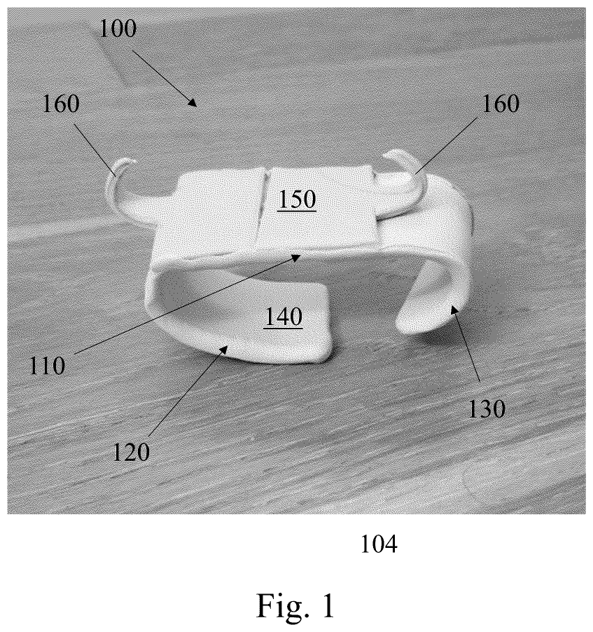

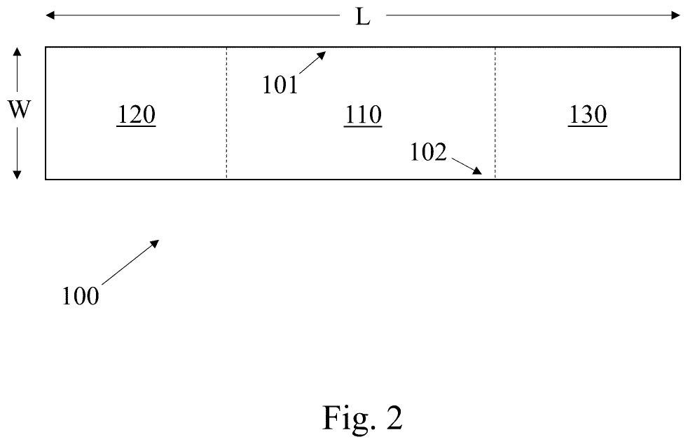

Referring now to FIG. 1, an exemplary embodiment of a zipper engagement device is shown. Device 100 is generally referred to herein as a cuff that is configured to easily slide on and off a user's hand to assist with the process of opening and closing zippers, such as the zipper of a bag, a jacket or other garment. Ease and efficiency are crucial when using adaptive equipment to perform a task like opening a zipper since it can be one of the many steps of a user's getting-ready routine. Thus, device 100 promotes independence in the user's everyday routines or tasks. Depending on user preference, the cuff may wrap around all or at least a portion of the user's palm to the back of the hand, just below the knuckles, as shown in FIG. 2A and FIG. 2B, and further explained below.

As contemplated herein and as shown in FIG. 1 and FIG. 2, device or cuff 100 comprises a substantially flat or planar central region 110 flanked by two opposing curved ends 120 and 130 that curve toward each other, thereby forming an interior surface 140 and an exterior surface 150 of cuff 100. In some embodiments, the leading ends of curved regions 120 and 130 are connected, thereby forming a single unit with two planar regions (top and bottom) and two curved end regions, and an opening through which the user's hand may slidably fit.

For purposes of illustrating the relative dimensions of cuff 100, FIG. 2 shows a two dimensional line drawing of cuff 100 with opposing ends 120 and 130 in a flat configuration and without any curvature. As shown, cuff 100 may have a length L and width W. It should be appreciated that cuff 100 may have any desired length L and will generally be dependent on the size of the user's hand and the desired amount of overlap curved regions 120 and 130 will have on the backside of the user's hand. For example, length L may be between 1 and 30 inches. In some embodiments, length L may be between 2 and 20 inches. In some embodiments, length L may be between 4 and 10 inches. In some embodiments, length L may be at least 1 inch, at least 2 inches, at least 3 inches, at least 4 inches, at least 5 inches, at least 6 inches, at least 7 inches, at least 8 inches, at least 9 inches, at least 10 inches, at least 11 inches, or at least 12 inches. In some embodiments, a top edge 101 has a length that is equal to the length of a bottom edge 102. In some embodiments, top edge 101 has a length that is less than the length of bottom edge 102.

It should also be appreciated that cuff 100 may have any desired width W and will also be generally dependent on the size of the user's hand. For example, width W may be between 0.2 and 5 inches. In some embodiments, width W may be between 0.5 and 3 inches. In some embodiments, width W may be between 1 and 2 inches. In some embodiments, width W may be at least 0.5 inches, at least 0.8 inches, at least 1 inch, at least 1.2 inches, at least 1.4 inches, at least 1.6 inches, at least 1.8 inches, at least 2 inches, at least 2.2 inches, at least 2.4 inches, at least 2.6 inches, at least 2.8 inches, or at least 3 inches. In some embodiments, width W may be consistent along the entire length L of cuff 100. In other embodiments, width W may be different in selected regions along length L of cuff 100. For example, central region 110 may have a width W that is greater than one or both of the widths of opposing curved sections 120 and 130. In another example, central region 110 may have a width W that is less than one or both of the widths of opposing curved sections 120 and 130.

Cuff 100 may further include one or more extensions 160. Extensions 160 are configured to releasably engage or otherwise be placed in contact with a portion of a zipper mechanism. In some embodiments and as shown in FIG. 1, extensions 160 may be hooks or hook shaped. In other embodiments, extensions 160 may be straight, curved, barbed, looped or any other shape suitable for engaging any portion of a zipper mechanism. Extensions 160 may form a single unit with cuff 100, or they may be releasably attached to any surface of cuff 100. In some embodiments, extensions 160 may extend from any portion of the outer surface 150 of cuff 100. For example, extensions 160 may extend from the outer surface 150 of flat central region 110, or they may extend from the outer surface 150 of one or both of curved regions 120 and 130. In some embodiments, cuff 100 may include at least two extensions 160 in the shape of hooks, where the hooks extend from outer surface 150 of flat central region 110. In such embodiments, the two hooks may be oriented such that they point inwardly towards each other, be pointed outwardly away from each other, or they may point in the same direction (both pointing towards region 120 or both pointed towards region 130).

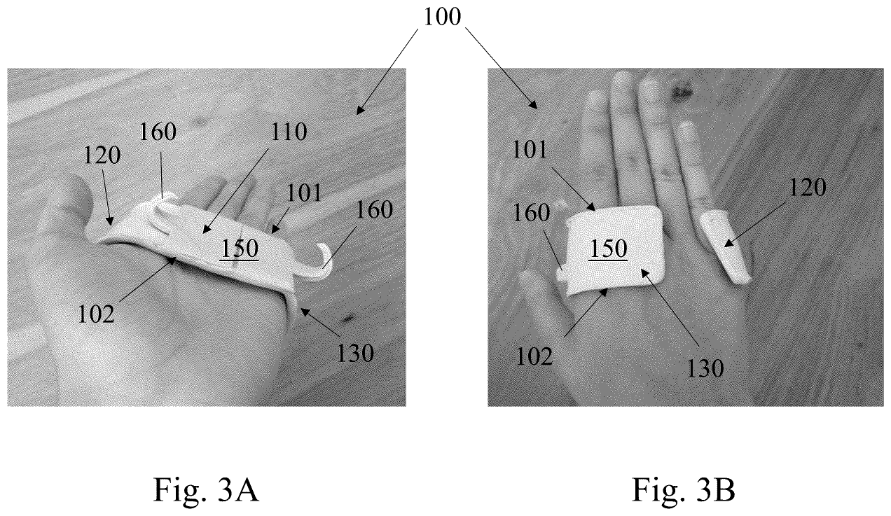

As shown in FIG. 3A and FIG. 3B, cuff 100 is configured to fit slidably onto a user's hand. Cuff 100 may be generally rigid in all sections, flexible in all sections, or alternatively it may be both flexible in one or more sections and rigid on one or more sections. For example, curved regions 120 and 130 may be flexible such that the curved regions are configured to expand around a larger sized hand of a user. In some embodiments, central region 110 is rigid while one or both of regions 120 and 130 are flexible. In some embodiments, some or all of inner surface 140 may be padded or cushioned. In some embodiments, some or all of inner surface 140 may be malleable or moldable to custom fit the contours of the user's hand.

Again, cuff 100 is configured to fit slidably onto a user's hand. In some embodiments, the fit is a friction fit. In other embodiments, the fit is loose and may be further secured by ties, straps, elastic bands or the like (not shown) that sinch or otherwise assist in tightening cuff 100 to a user's hand. As contemplated herein, cuff 100 is positioned such that inner surface 140 in central region 110 is in contact with the dorsal or back side of the user's hand and fingers, and the inner surface 140 of curved regions 120 and 130 wrap around the dorsal or back side of the user's hand and fingers onto at least a portion of the palmar or front side of the user's hand and fingers. In some embodiments, cuff 100 is positioned such that inner surface 140 in central region 110 is in contact with the palmar or front side of the user's hand and fingers, and the inner surface 140 of curved regions 120 and 130 wrap around to the dorsal or back side of the user's hand and fingers. It should be appreciated that cuff 100 may be positioned in any orientation relative to the user's hand, according to the user's preference. In some embodiments, the top edge 101 of cuff 100 is shorter in length than bottom edge 102, thereby creating a shorter perimeter at top edge 101 as compared to bottom edge 102. Thus, when cuff 100 is fitted over a user's hand, the smaller perimeter of top edge 101 prohibits cuff 100 from sliding too far down the wider portion of the user's palm.

Device 100 may be composed of rigid and/or flexible polymers such as plastics, thermoplastics, or other materials such as wood or metals, or any combinations of materials. Device 100 may be constructed as a single unit via molding or 3D printing, or it may be constructed as an assembly of multiple manufactured components. In some embodiments, device 100 may be composed of a medical-grade plastic. In some embodiments, device 100 may include an antimicrobial surface. Device 100 may further be composed of washable or sterilizable materials.

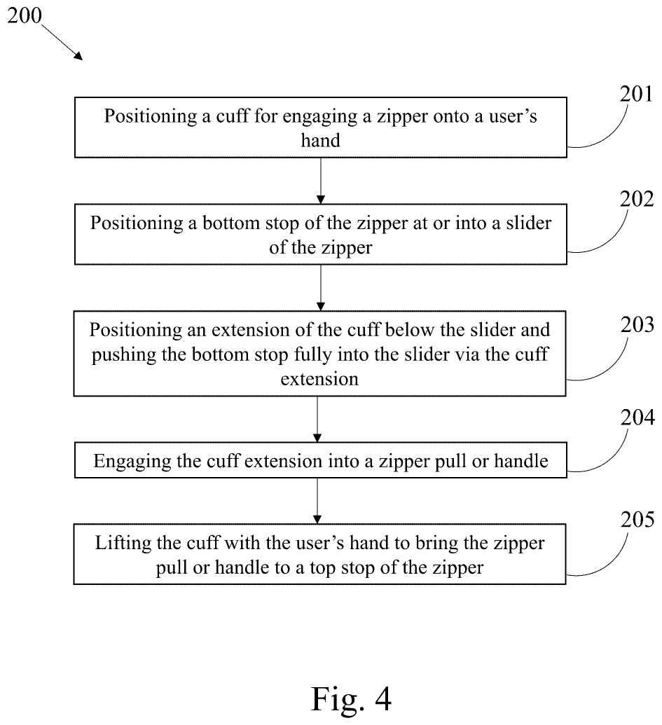

Now referring to FIG. 4, shown is a flow chart of a method 200 for engaging a zipper. Method 200 utilizes any of the embodiments of cuff or device 100 for engaging a zipper. As contemplated herein, device 100 and method 200 may be used on a zipper or activity where a hook or other shaped extension 160 may be useful, such as lifting up small items, opening objects, and the like.

At step 201, a device (e.g., cuff 100) is positioned onto a user's hand. This may include sliding the cuff onto the user's hand and/or optionally securing the cuff onto the user's hand with a tie, strap, elastic band, or the like. The device, or cuff 100, may be positioned onto the user's hand according to the user's preference. For example, cuff 100 can be positioned such that inner surface 140 in central region 110 is in contact with the palmar or front side of the user's hand and fingers. Alternatively, inner surface 140 in central region 110 can be in contact with the dorsal or back side of the user's hand and fingers.

At step 202, a bottom stop of the zipper is positioned at or into a slider of the zipper. In some embodiments, the user may maneuver the article of clothing attached to the zipper to help move the bottom stop at the slider or ideally into the slider, if possible. For example, the user may insert their free hand into a jacket pocket and then use arm movements to slide the bottom stop into position with the zipper slider. In some embodiments, the user may use their other hand or use any sort of other secondary device to help move the bottom stop at or into the zipper slider.

At step 203, the tip of an extension of the cuff, such as the tip of hook 160, is positioned on the bottom stop such that an exerted pressure onto the bottom stop allows the bottom stop to be pushed fully into the zipper slider. For example, the tip of hook 160 may be used to press upward via the user lifting their entire hand and device 100 upward from beneath the bottom stop to ensure it is inserted fully into the zipper slider.

At step 204, an extension of the cuff is positioned into a zipper pull tab or handle. For example, the zipper pull tab typically includes an opening through which the tip of hook 160 may slide through for engagement.

Lastly, at step 205, the cuff with the extension engaged to the zipper pull is lifted upward until it reaches the top stop of the zipper mechanism, thereby completing the zipping function. This may be accomplished by utilizing the larger muscles of the arm to lift the hand with the cuff upward.

In a similar fashion, the device may be used to unzip a zipper mechanism by simply positioning a cuff extension, such as a hook 160 pointed downward, into the opening of the zipper pull and utilizing the larger muscles of the arm to lower the hand with the cuff downward. This continued downward movement will also pull the zipper slider out of the bottom stop and disengage the entire zipper mechanism.

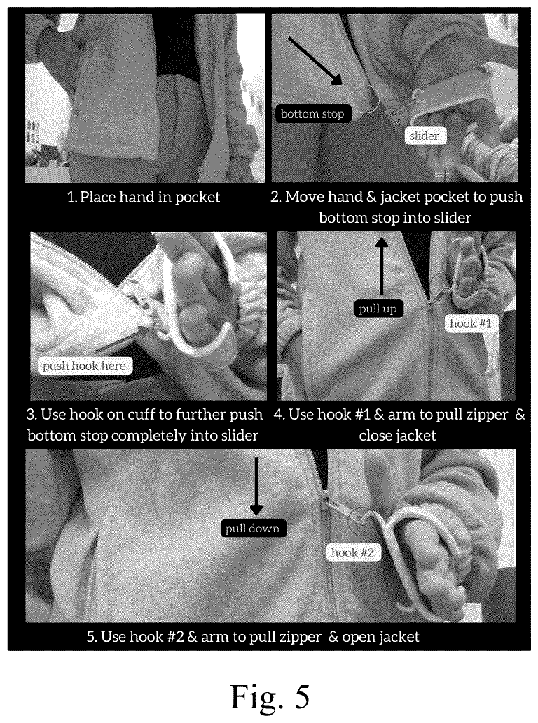

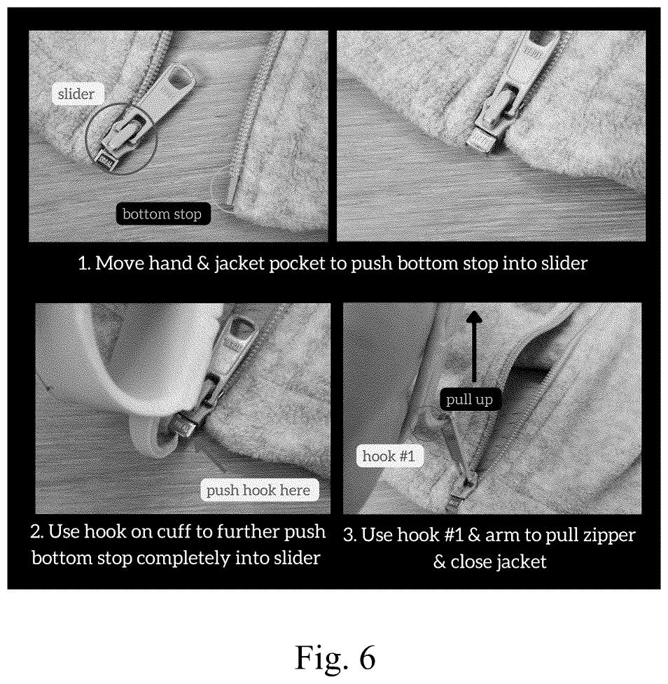

FIG. 5 and FIG. 6 depict some or all steps of method 200 being performed by a user to complete the zipping process of a jacket. For example, and as shown in FIG. 5 and FIG. 6, the user may use their hand in a pocket of the jacket they are wearing to help position the bottom stop into the slider of the zipper. The red arrow points to where the point of the first hook should be applied to further push the stop into the slider. After this, the hook is engaged with the zipper pull or handle, and the user lifts their arm to lift the zipper pull up and close the jacket. Also shown is the removing of the hook from the zipper puller once the slider reaches the top stop. To unzip the jacket, a second hook pointing downward engages the zipper pull and the hand is moved downward until the bottom stop is reached.

It should be appreciated that the aforementioned methods may be performed on a zipper or other mechanical mechanism in any orientation. Accordingly, while the exemplary method relates to a zipper oriented in a generally vertical manner, the exemplary method may apply to zippers that are typically horizontally oriented, such as the zipper of a bag, or any other directional orientation encountered. Thus, any steps identifying a bottom or top of a zipper may apply in any orientation, and likewise any exerted forces performed by the user necessary for opening and closing the zipper mechanism apply in accordance with the zipper orientation.

Overall, device or cuff 100 allows users with limited hand function, dexterity, and strength to open or close zippers. Users with conditions like severe arthritis, cerebral palsy, spinal cord injuries, or strokes can experience difficulties with fine motor skills. Thus, device or cuff 100 may aid with performing movements such as trouble pinching, gripping, forming a fist, and manipulating small objects, via use of larger muscles of the arm and shoulder.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention.

What is claimed is:

1. A device for engaging a zipper, comprising:
a cuff having a substantially flat central region with two opposing ends curved towards each other, thereby defining a cuff inner surface and an outer surface; and
at least one extension extending outwardly from the outer surface of the cuff.

2. The device of claim 1, wherein the at least one extension extends outwardly from the outer surface of the substantially flat region of the cuff.

3. The device of claim 1, wherein the cuff is rigid in the substantially flat central region.

4. The device of claim 3, wherein the cuff is flexible at the two opposing curved ends.

5. The device of claim 1, wherein the at least one extension is a hook.

6. The device of claim 1, wherein the at least one extension includes two hooks pointed in opposite directions.

7. The device of claim 5, wherein the at least one extension includes two hooks pointed towards each other.

8. The device if claim 1, wherein the at least one extension is releasably fixed to the cuff.

9. The device of claim 1, wherein the inner surface is malleable.

10. The device of claim 1, wherein the inner surface is padded.

11. The device of claim 1, wherein the cuff includes a top edge and a bottom edge along its length, and wherein the length of the top edge is shorter than the length of the bottom edge.

12. The device of claim 1, wherein the cuff has a width, and the width of the flat central portion is different than the width of the two opposing curved ends.

13. The device of claim 1, wherein the cuff is configured to make a friction fit when positioned on a user's hand.

14. The device of claim 1, wherein the cuff is configured such that the at least one extension extends outward from the dorsal side of the user's hand when the cuff is positioned on the user's hand.

15. The device of claim 1, wherein the cuff is configured such that the at least one extension extends outward from the palmar side of the user's hand when the cuff is positioned on the user's hand.

16. A method for engaging and closing a zipper mechanism, comprising the steps of:
providing a device for engaging the zipper, comprising;
a cuff having a substantially flat central region with two opposing ends curved towards each other, thereby defining a cuff inner surface and an outer surface;
at least one extension extending outwardly from the outer surface of the cuff;
positioning the device onto a user's hand;
positioning a bottom stop of a zipper at or into a zipper slider;
positioning the at least one extension of the cuff below the bottom stop and pushing the bottom stop fully into the slider via the cuff extension;
engaging the at least one extension of the cuff with a zipper pull or handle; and
pulling the zipper pull or handle upward via the cuff extension, such that the zipper mechanism is engaged.

17. A method for opening and disengaging a zipper mechanism, comprising the steps of:
providing a device for engaging the zipper, comprising:
a cuff having a substantially flat central region with two opposing ends curved towards each other, thereby defining a cuff inner surface and a cuff outer surface;
at least one extension extending outwardly from the outer surface of the cuff;
positioning the device of onto a user's hand;
engaging the at least one extension of the cuff with the zipper pull or handle; and
pulling the zipper pull or handle downward via the cuff extension, such that the zipper mechanism is disengaged.

18. The method of claim 16, wherein the at least one extension is a hook.

19. The method of claim 16, wherein the at least one extension includes two hooks pointed in opposite directions.

20. The method of claim 16, wherein the at least one extension includes two hooks pointed towards each other.

21. The method of claim 16, wherein the zipper mechanism is integrated into an article of clothing worn by the user.
